(19) United States
(12) Patent Application Publication
(10) Pub. No.: US 2018/0213778 A1
(43) Pub. Date: Aug. 2, 2018

(54) METHODS AND COMPOSITIONS FOR TREATMENT OF CITRUS GREENING

(71) Applicant: Minn-Dak Farmers Cooperative, Wahpeton, ND (US)

(72) Inventor: Allen E. Larson, Detroit Lakes, MN (US)

(21) Appl. No.: 15/883,767

(22) Filed: Jan. 30, 2018

Related U.S. Application Data
(60) Provisional application No. 62/452,297, filed on Jan. 30, 2017.

(51) Int. Cl. A01N 43/16; B05B 11/00

(52) U.S. Cl. CPC A01N 43/16; B05B 11/00

(57) ABSTRACT

Methods and systems for the prevention of citrus greening by application of liquid sugar to citrus leaves to otherwise inhibit, reduce and or eliminate the ability of psyllids to transmit the bacteria responsible for citrus greening. Liquid sugar, in either undiluted or diluted solutions, can be directly or indirectly applied to citrus leaves to treat psyllids at various stages of development. The use of liquid sugar to combat citrus greening can also increase the amount of caloric energy directly available to the citrus tree for photosynthesis, and provide energy to the soil to enhance microbial activity within the soil. Furthermore, the use of liquid sugar to prevent citrus greening is non-harmful to bees and can encourage the return of commercial beekeepers to citrus groves.

### CROSS-REFERENCE TO RELATED APPLICATION

The present application claims the benefit of U.S. Provisional Application No. 62/452,297, filed Jan. 30, 2017, which is hereby incorporated herein in its entirety by reference.

### TECHNICAL FIELD

The present invention is related to preventing citrus greening. More particularly, the present invention is directed to foliar application of sugar compositions including liquid sucrose so as to inhibit, reduce and/or eliminate the presence of psyllids on orange trees.

### BACKGROUND

Citrus greening is a bacterial disease that affects the leaves of citrus trees and ultimately leads trees to experience stunted growth and produce small, irregularly shaped fruit possessing a bitter taste. As the leaves are impacted, they are not able to receive the nutrients they need nor are they able to properly supply the tree with energy. The bacteria is transmitted by the psyllid insect, either the Asian citrus psyllid or the African citrus psyllid. Citrus greening began impacting U.S. citrus farms in the mid-2000's and now threatens the entire U.S. citrus industry.

There is presently no known cure for citrus plants that have been infected with citrus greening. Management of citrus greening generally involves antibacterial management, sanitation, removal of infected plants and frequent monitoring and scouting. One method of managing citrus greening in commercial orchards has been to target psyllids with pesticides. While these pesticides can impact the psyllid population, they can similarly impact beneficial insects such as, for example, honeybees. In addition, the use of pesticides can negatively impact microbial activity within soil.

As such, it would be beneficial to develop compositions and methods of application that would inhibit, reduce and/or eliminate the ability of psyllids to transmit the bacteria associate with citrus greening. It would be of further benefit to develop compositions and methods of application that successfully targeted psyllids without harming beneficial insect or negatively impacting soil conditions.

### SUMMARY

The present invention is directed to sugar based compositions that can be applied directly to leaf foliage to otherwise inhibit, reduce and or eliminate the ability of psyllids to transmit the bacteria responsible for citrus greening. In some embodiments, the sugar based composition can include liquid sucrose that is applied directly to citrus leaves with various stages of psyllid development present. By applying liquid sucrose directly to citrus leaves, the liquid sucrose can inhibit, reduce and/or eliminate psyllid development at one or more of their development stages, increase the amount of caloric energy directly available to the citrus tree for photosynthesis, and provide energy to the soil to enhance microbial activity within the soil. In addition, the application of liquid sucrose is non-harmful to bees and would encourage the return of commercial beekeepers to citrus groves.

In one aspect, the present invention is directed to a method of reducing and/or preventing the spread of citrus greening in citrus orchards by targeting the psyillids that transmit the bacteria responsible for citrus greening. The method can comprise the application of liquid sugar directly to citrus trees such that the liquid sugar is present on leaves of the citrus trees. In one representative embodiment, application can include the direct application of liquid sugar to the leaves for example by directly spraying the liquid sugar onto the citrus leaves. Alternatively, the application method can include indirectly application of the liquid sugar to the leaves, for example, by drift spraying. In some embodiments, the method can comprise diluting the liquid sugar prior to application on the citrus leaves.

In another aspect, the present invention is directed to a system for use in reducing and/or preventing the spread of citrus greening. Generally, the system can comprise a spray apparatus and a liquid tank for holding a liquid sugar composition. Generally, the spray apparatus can comprise a spray applicator for directly or indirectly applying the liquid sugar composition from the liquid tank onto citrus leaves. In some embodiments, the liquid tank contains the liquid sugar composition in an aqueous solution of approximately 66.5%-67.5% Brix. In some embodiments, the liquid sugar composition can include the aqueous solution of 66.5%-67.5% Brix that is further diluted with water at a ratio of 9 gallons water to 1 gallon liquid sugar.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is flow chart illustrating a method of reducing and/or preventing the spread of citrus greening according to an embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Representative embodiments of the present invention use direct or indirect application of liquid sugar onto citrus leaves to prevent the spread of bacteria causing citrus greening by the psyllid insect, either the Asian citrus psyllid or the African citrus psyllid. As used throughout the present application, the term “liquid sugar” generally refers to commercially available liquid sugar that is typically formed by dissolving crystalline sucrose in heated water. Liquid sugar is commercially available from various suppliers including, for example, United Sugars™ Corporation of Edina, Minn. at Brix levels of 66.5%+/−0.2% or 67.5%+/−0.2%.

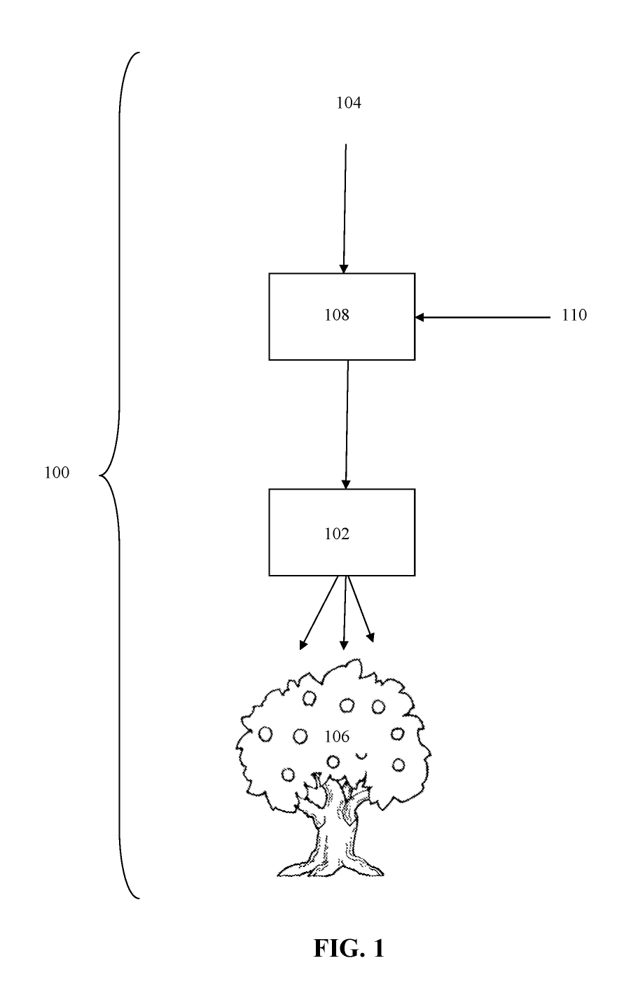

With reference to FIG. 1, a representative method 100 of reducing and/or preventing the spread of citrus greening in citrus orchards generally involves an application step 102 of applying liquid sugar 104 to citrus leaves 106, such that any psyllid insects, regardless of their development/life stage, that land on the citrus leaves will come into contact with the liquid sugar 104. Generally, application step 102 can involve the direct application of liquid sugar 104, for example, by spraying the liquid sugar 104 directly onto the citrus leaves 106 in liquid form using a hand or mechanical spray applicator. Alternatively, application step 102 can involve the indirect application of liquid sugar 104, for example, by drift spraying, in which the liquid sugar 104 can be pressurized and applied as a jet of dispersed droplets using conventional spray applicators.

In application step 102, commercial liquid sugar can be applied at Brix levels of approximately 66.5%-67.5%. Alternatively, method 100 can further comprise a dilution step 108 in which the liquid sugar 104 is diluted with water 110 at ratios of 9 gallons of water 110 to one gallon of liquid sugar 104 in a suitable liquid tank. Dilution step 104 can help to prevent plugging of the spray equipment so as reduce downtime and/or maintenance of the spray equipment.

Asian Psyllid Testing

Testing was performed to determine the contact toxicity of liquid sugar 104 on a California population of Asian psyllids (Diaphorina citri). This testing compared the impacts of water application, liquid sugar 104 and a traditional pesticide, Danitol® 2.4EC (fenpropathrin, 16 fl.oz/acre) available from Valent USA Corp of Walnut Creek, Calif. In the first experiment, the liquid sugar 104 was undiluted while in the second set of experiments, the liquid sugar 104 was diluted at a ratio of 9 gallons water 110 to 1 gallon liquid sugar 104. The Danitol 2.4EC was applied at the recommended label rate based on 100 gpa dilution.

Insects and Insecticide

200 Diaphorina citri adults were field-collected from Los Angeles County (N34.12, W117.9) to establish the colony. Diaphorina citri nymphs were reared on curry plants, Murraya koenigii (L) Sprengel (Sapindales: Rutaceae), in an insectary as described by Soper et al. (2014). Molecular techniques were used every 3 months to confirm HLB free insects. To obtain the desired nymphal stages, a cohort of curry plants were exposed to newly emerged adults to lay eggs. After 48 h, adults were removed and plants transferred to new insect cages (BugDorm® BD2120F MegaView Science, Taiwan) and reared until the desired instars were obtained. Wing pads were used to visually differentiate early and late instars (Hall 2008). The first and second D. citri instars were defined as “early instars” and third to fifth instars as “late instars”.

Contact Insecticidal Efficacy Against Early/Late Instar Nymphs

Experiments were conducted to measure the contact toxicity of liquid sugar 104. A leaf disk made by cutting a fully expanded young leaves with a sharpened bistoury scalpel and placed individually into Petri dishes (60×11 mm) containing 20 ml of 2% water agar. A piece of curry leaf with 10-15 first and second instar D. citri nymphs was placed on top of the leaf disk for 24 h to allow the nymphs to migrate to the leaves. Next, 1.5 ml of liquid sugar 104, Danitol as positive control or water was applied to the leaves containing early instars with a Master Airbrush Model E91 and TC-20 compressor at 20 psi. Each Petri dish was one replicate, and six replicates were set up. The experiment was conducted three times. Mortality was recorded after 3 days. Dead nymphs were defined as those not able to move their body or antennae. All Petri dishes were maintained in the laboratory at room temperature (12L:12D, 22-25° C.). The same methodology was used to evaluate contact efficacy of the tested insecticides against late instars (Table 2).

Contact Insecticidal Efficacy Against D. citri Adults

In order to study contact efficacy of MDF 101055, approximately ten adult psyllids were placed inside plastic vials (3.5 inch length, 1 inch diameter, 1 cm whole on top of vials covered with 425 microns mesh) one hour prior to the experiment. Small flush leaves were added to each experimental vial. There were six replicate vials for each trial and the trial was replicated three times. Liquid sugar 104 and Danitol were sprayed through the mesh of the top of the vials using a Master Airbrush Model E91 and TC-20 compressor at 20 psi to ensure a 100% coverage. Control vials received air only. Mortality of adult psyllids was assessed after 72 hours of treatment application. Psyllids that did not move when gently probed were considered dead.

Results

Liquid sugar 104 and Danitol caused significantly higher nymphal (58-100%) and adult (100%) mortality compared to the water control when applied directly to the early and late instar nymphs and adults (Table 1). Nymph and adult mortality were lower for liquid sugar 104 as compared to Danitol.

TABLE 1
Contact efficacy (average % mortality) of undiluted liquid sugar for early
and late instar nymphs and adults of D. citri under laboratory conditions.

| | % Mortality ± SE (72 h) | | |
|---|---|---|---|
| Treatment | Early instars | Late instars | Adults |
| Water (nymphs) | 3.1 ± 1.3 c | 3.2 ± 1.3 c | 7.0 ± 2.7 c |
| air (adults) | | | |
| Danitol | 100 ± 0 a | 100 ± 0.0 a | 100 ± 0.0 a |
| Undiluted liquid | 71.1 ± 6.4 b | 72.4 ± 23.2 b | 60.8 ± 5.0 b |
| sugar | | | |

Means followed by different lowercase letters within each column are significantly different according to Tukey's HSD, (P < 0.05).

TABLE 2
Contact efficacy (average % mortality) of diluted liquid sugar for early
and late instar nymphs and adults of D. citri under laboratory conditions.

| | % Mortality ± SE (72 h) | | |
|---|---|---|---|
| Treatment | Early instars | Late instars | Adults |
| Water (nymphs) | 3.1 ± 1.3 c | 10.4 ± 2.1 c | 6.4 ± 1.7 c |
| air (adults) | | | |
| Danitol | 100.0 ± 0.0 a | 100.0 ± 0.0 a | 100.0 ± 0.0 a |
| Diluted liquid | 72.8 ± 4.6 b | 58.0 ± 6.7 b | 65.0 ± 3.9 b |
| sugar | | | |

Means followed by different lowercase letters within each column are significantly different according to Tukey's HSD, (P < 0.05).

Observations

In the first set of experiments using undiluted liquid sugar resulted in some nozzle clogging that required sprayer disassembly. The Danitol treatment was dry after a couple of hours, but the undiluted liquid sugar 104 remained as wet particles throughout the 72 hours of the study. In the second set of experiments using diluted liquid sugar 104, stickiness was present but not as prominent as the undiluted liquid sugar 104. We did not experience any clogging of nozzles when using the diluted liquid sugar 104 solution. There were wet particles in the vials sprayed by the diluted liquid sugar 104 solution but the wet particles were much smaller compare to undiluted liquid sugar 104. Danitol was completely dry after 2-5 hours whereas diluted liquid sugar 104 solution remained wet after 72 hours. Both undiluted and diluted liquid sugar 104 applied directly to the psyllids caused 58-73% mortality of ACP nymphs and adults.

As described above, liquid sugar 104, either undiluted or diluted, can be used to increase psyllid mortality as compared to non-treatment. While the efficacy of liquid sugar 104 is less than a conventional pesticide, liquid sugar 104 is presumed to be non-harmful to advantageous insects such as bees as liquid sugar has been and continues to be sold to the bee industry for direct feeding as a primary source of carbohydrates. As such, the use of liquid sugar 104 as a means of controlling/killing psyllids would likely be supported by the bee industry and encourage the return of the bee industry to citrus groves.

Finally, as taught in US Patent Publications 2016/0262390A1 and 2016/0280613A1, the disclosures of which are herein incorporated by reference in their entirety, the application of sugar to fields is believed to increase crop yield by favorably impacting the microfloura present within the soil. As such, the use of liquid sugar to control psyllid populations within citrus groves including an overspray, dripping or spray drift would not be expected to negatively impact soil or surrounding agricultural areas, whereas some pesticides have been found to reduce the microbiological activity within soil and can negatively impact citrus grove soil or soil of the surrounding areas. At the same time, the application of liquid sugar can also increase the amount of caloric energy directly available to the citrus tree for photosynthesis.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for treating citrus greening, comprising:
applying liquid sugar to citrus leaves; and
exposing psyllid insects that come into contact with the citrus leaves to the liquid sugar, whereby psyllid insects in stages of development including early instars, later instars and adults experience enhanced mortality rates.

2. The method of claim 1, wherein the liquid sugar comprises a Brix level of about 66.5%-67.5%.

3. The method of claim 2, wherein the enhanced mortality rate exceeds 60% across all stages of development.

4. The method of claim 3, wherein the enhanced mortality rate exceeds about 60% for adult psyllids, about 71% for early instar psyllids and about 72% for late instar psyllids.

5. The method of claim 2, further comprising:
diluting the liquid sugar with water prior to application.

6. The method of claim 5, wherein the liquid sugar is diluted with water at a ratio of at least 9 gallons water to 1 gallon liquid sugar.

7. The method of claim 6, wherein the enhanced mortality rate exceeds about 58% across all stages of development.

8. The method of claim 7, wherein the enhanced mortality rate exceeds about 58% for late instar psyllids, about 65% for adult psyllids and about 72% for early instar psyllids.

9. The method of claim 1, wherein applying the liquid sugar to citrus leaves comprises directly applying the liquid sugar to the citrus leaves.

10. The method of claim 1, wherein applying the liquid sugar to citrus leaves comprises indirectly applying the liquid sugar to the citrus leaves.

11. The method of claim 1, wherein the liquid sugar remains wet following application on the citrus leaves for at least 72 hours.

12. A system for practicing the method of claim 1, the system comprising:
a liquid tank for holding the liquid sugar; and
a spray applicator for applying the liquid sugar from the liquid tank onto the citrus leaves.
